(19) United States
(12) Patent Application Publication
(10) Pub. No.: US 2006/0100555 A1
(43) Pub. Date: May 11, 2006

(54) Apparatus and system for treating cellulite

(76) Inventors: Merry M. Cagle, Winston, GA (US); Quentin Utz, Alpharetta, GA (US); Jorge Almirall, Acworth, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/267,592

(22) Filed: Nov. 4, 2005

Related U.S. Application Data
(60) Provisional application No. 60/625,458, filed on Nov. 5, 2004.

(51) Int. Cl. A61H 7/00; A61H 15/00

(52) U.S. Cl. 601/6; 601/113; 601/84; 601/63; 601/69

(57) ABSTRACT

A system and apparatus for treating cellulite that includes a housing having a first opening for communication with a suction source and a second opening in communication with the first opening for delivering suction from the suction source to the body. The second opening is located adjacent a bottom portion of the housing and a plurality of roller balls are disposed around the second opening for delivering massage treatment. Because the roller balls are permitted to rotate freely and smoothly, the housing may be moved across the skin in any direction for delivering massage treatment and suction to the body for treating cellulite.

### RELATED APPLICATION

This application claims the benefit of priority of U.S. provisional application Ser. No. 60/625,458, filed Nov. 5, 2004, which is relied on and incorporated herein by reference.

### FIELD OF THE INVENTION

The present invention relates generally to an improved apparatus and system for massaging the human body. In particular, the present invention relates to a portable system and hand-held apparatus for delivering massage treatment and suction to the body in order to treat cellulite.

### BACKGROUND OF THE INVENTION

It has been well known for centuries that massage therapy may be used to treat the human body for remedial or hygienic purposes. Massage therapy is highly beneficial because it relaxes and stretches tight muscles, improves circulation, increases range of motion, frees trapped nerves, and relieves muscle spasm. It is also known that more effective results can be secured if the area being massaged is placed under a vacuum or partial vacuum, as this tends to increase the circulation still further in the area being treated. Such a combination of massage treatment and suction has been particularly used in the treatment of cellulite, a fatty deposit typically found around the thighs and buttocks which causes the skin to have a dimpled or uneven appearance.

Accordingly, various types of devices have been proposed to deliver massage treatment and suction to the body for treating cellulite. Such devices typically include a housing in connection with a suction source. The suction source lifts the skin into the housing where it is kneaded by various kinds of rollers. The rollers are usually cylindrical in shape and may be motorized or mechanically activated to squeeze the skin between the rollers. Such equipment is generally expensive, allows for only limited movement across the skin, and in many cases requires assistance from another, such as a professional, to manipulate the device and deliver the treatment.

A need therefore exists for an improved apparatus and system for treating cellulite that overcomes the shortcomings found in the prior art.

### SUMMARY OF THE INVENTION

The present invention answers this need by providing a portable system that includes a hand-held, easy to manipulate apparatus that is suitable for an individual to use on his or her own body, and which may be moved across the skin in any direction for delivering massage treatment and suction to the skin for treating cellulite.

The cellulite treatment system of the present invention includes a portable container and a housing sized to fit within the portable container for storage and ease of transportation. A suction source is located inside the portable container. The housing includes a first opening for communication with the suction source and a second opening in communication with the first opening for delivering suction from the suction source to the body. The second opening is located adjacent a bottom portion of the housing and a plurality of freely rotatable roller balls are disposed around the second opening for delivering massage treatment.

In operation, the user grasps the housing, presses the bottom portion of the housing against the body, and moves the housing across the skin to provide massage treatment and suction to the skin. The negative pressure provided by the suction source pulls the skin into the second opening of the housing. As the housing is moved across the skin, the skin is massaged by the roller balls. Because the roller balls are freely rotatable, the housing may be moved across the skin in any direction for delivering massage treatment and suction to the body for treating cellulite.

In one embodiment, the plurality of roller balls are mounted in cavities adjacent the bottom portion of the housing.

In another embodiment, the present invention further includes a motor located within the housing for subjecting the housing to mechanical vibration to facilitate in the delivery of massage treatment.

In still another embodiment, the present invention further includes a sensor integrated into the housing for monitoring movement of the housing across the skin. Accordingly, if the sensor detects a lack of or insufficient movement of the housing, an indication may be provided to prompt the user to resume movement of the housing to prevent bruising or marking. Such an indication may include substantially reducing or shutting off the suction from the suction source or activating an alarm.

Therefore, it is an object of the present invention to provide a portable system and apparatus for individual use that may be easily manipulated in any direction across the skin to safely deliver massage treatment and suction to the body for treating cellulite.

Further objects, features and advantages will become apparent upon consideration of the following detailed description of the invention when taken in conjunction with the drawing and the appended claims.

### BRIEF DESCRIPTION OF THE DRAWINGS

FIG. 1 is a perspective view of the portable container (with cover detached) and the housing in an embodiment of the present invention.

FIG. 2 is a front perspective view of the portable container (with cover attached) in an embodiment of the present invention.

FIG. 3 is a side elevation view of the housing in an embodiment of the present invention.

FIG. 4 is a bottom view of the housing in an embodiment of the present invention.

FIG. 5 is a schematic diagram of the cellulite treatment system in an embodiment of the present invention.

### DETAILED DESCRIPTION OF THE INVENTION

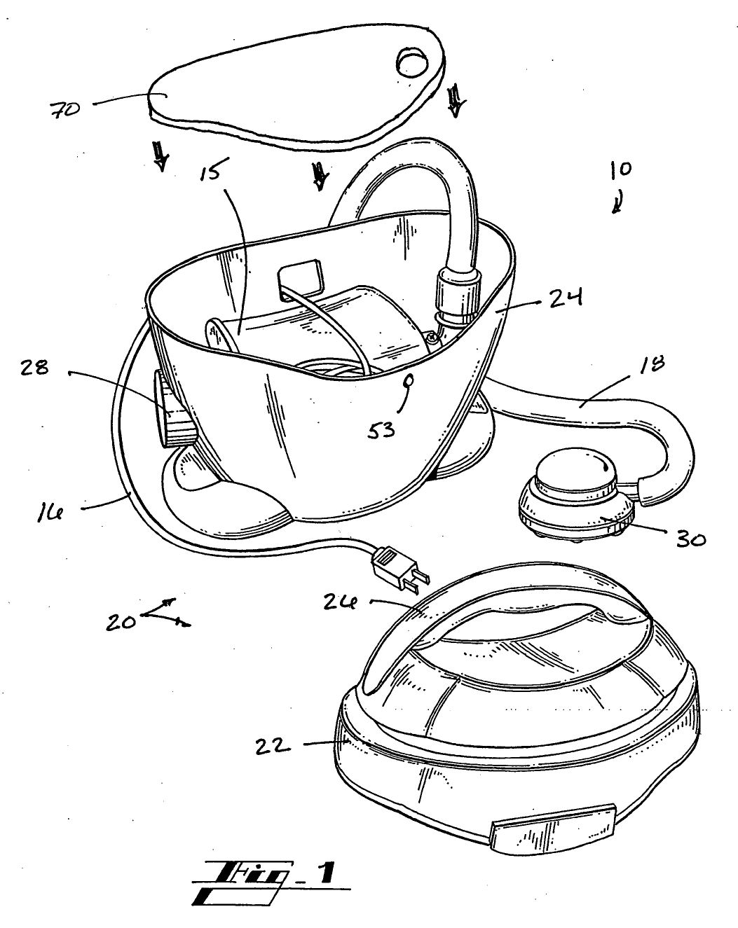

With reference to FIG. 1, a cellulite treatment system 10 in accordance with the present invention is illustrated. The cellulite treatment system 10 comprises a portable container 20 and a housing 30. The portable container includes a cover 22 and a base 24. The cover 22 may be detachably connected or pivotably connected to the base 24 so that the cover 22 may be detached as shown in FIG. 1 or flipped open (not shown) for access to the contents of the portable container 20. The housing 30 is adapted to be connected to a suction source 15 located within the portable container 20 via a flexible hose 18. The suction source 15 may be connected to a power source (not shown) via a power cord 16. An exhaust port 28 may be provided on the base 24 of the portable container 20 to permit emissions from the suction source 15 to exit the portable container 20.

In other embodiments, the housing 30 may be connected to, and used with, an external suction source, rather than the suction source 15 located in the portable container 20. It will be appreciated that the suction source 15 and/or the external suction source may be any suitable source of negative pressure, such as a vacuum, and may deliver suction of variable or adjustable intensity or may deliver suction that is pulsating in intensity.

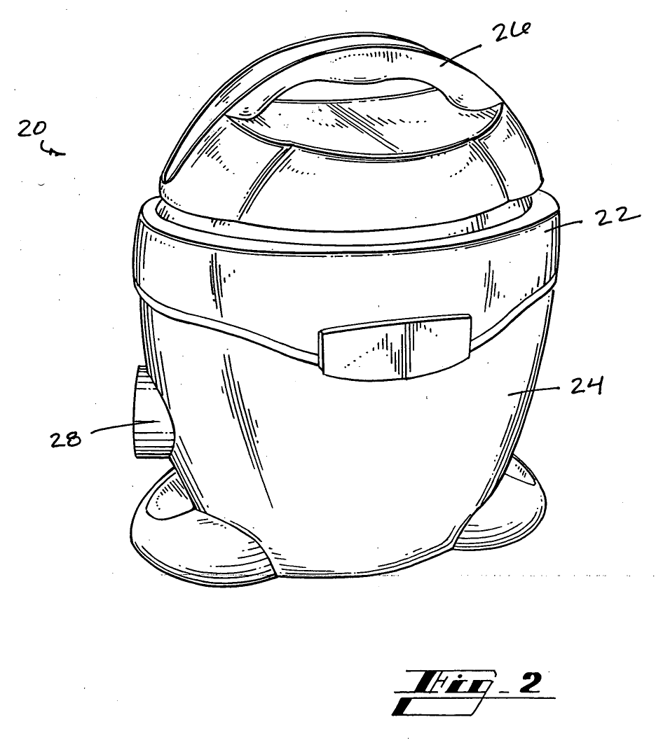

The housing 30 is sized to fit within the portable container 20 for storage and ease of transportation. Accordingly, an individual may conveniently carry the cellulite treatment system 10 by placing the housing 30, hose 18, and power cord 16 inside the base 24 of the portable container 20, attaching or closing the cover 22 of the portable container 20 as shown in FIG. 2, and lifting the container 20 via a handle 26, strap, or the like provided on the portable container 20, such as on the cover 22. A shelf 70 (FIG. 1) may be provided for placing inside the portable container 20 and above the suction source 15 to hold the housing 30 and hose 18.

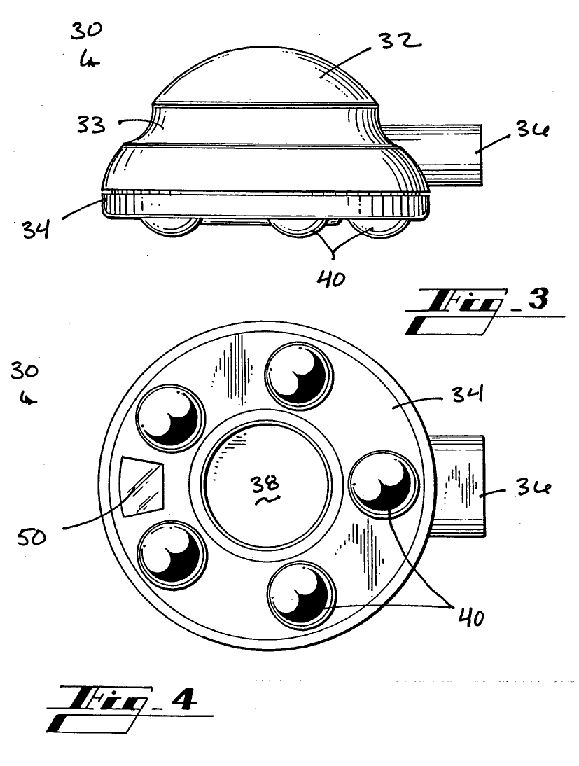

With reference to FIGS. 3-5, the housing 30 includes a top portion 32 adapted for ease of manipulation by a user and a bottom portion 34. The housing 30 further includes a first opening 36 for communication with the suction source 15 and a second opening 38. The second opening 38 is in communication with the first opening 36 via an internal chamber 37 (FIG. 5) of the housing 30. The second opening 38 is located adjacent the bottom portion 34 of the housing for delivering suction from the suction source 15 to the body. A plurality of roller balls 40 are disposed around the second opening 38 for delivering massage treatment. Therefore, the present invention provides a combination of massage treatment and suction for the treatment of cellulite.

In the described embodiment, the top portion 32 of the housing 30 is substantially hemispheric and is sized to fit mainly within the palm of the user like a knob. A groove 33 (FIG. 3) may be provided on the top portion 32 to facilitate grasping and manipulation. In other embodiments, the top portion 32 may be of any suitable shape and may include a handle, a stap, or the like to assist in manipulation.

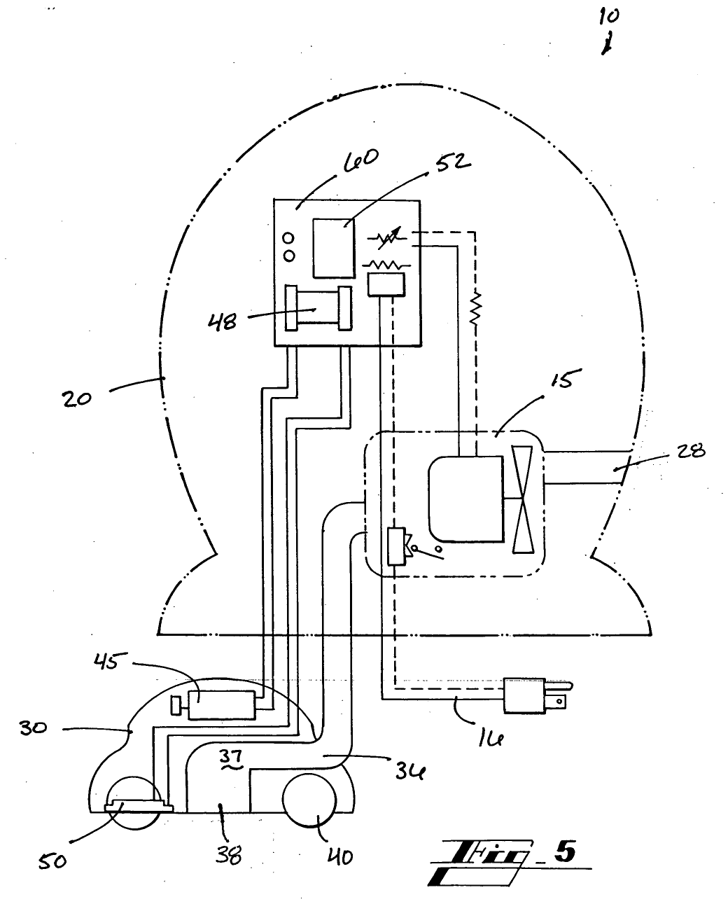

With reference to FIG. 4, in the described embodiment the second opening 38 of the housing 30 is substantially circular. The bottom portion 34 of the housing 30 includes a substantially flat surface that forms a ring around the second opening 38. The plurality of roller balls 40 are mounted within and held captive by cavities at the bottom portion 34 of the housing 30 and are arranged about the periphery of the second opening 38 such that the arrangement of roller balls 40 and the periphery of the second opening 38 are substantially concentric. It will be appreciated that the roller balls 40 may be incased in a suitable material to facilitate movement across the skin and aid in massage.

In the described embodiment, the housing 30 is constructed of molded plastic and includes rubber overmold on the top portion 32 to prevent slippage. The top portion 32 and the bottom portion 34 are joined together using screw assemblies. In other embodiments, the housing 30 may be constructed of ceramic or any suitable material and the top portion 32 and the bottom portion 34 may be configured to snap together or may be joined using an adhesive, staples, or the like. In one embodiment, the bottom portion 36 of the housing 30 may be constructed of a flexible material so as to conform to the anatomy during treatment.

In accordance with the present invention, the user grasps the housing 30, presses the bottom portion 36 of the housing 30 against the body, and moves the housing 30 across the skin to provide massage treatment and suction to the skin. In use, the negative pressure provided by the suction source 15 pulls the skin into the second opening 38 of the housing 30. As the housing 30 is moved across the skin, the skin is massaged by the roller balls 40. Each of the roller balls 40 is configured to be freely rotatable. Thus, the housing 30 may be moved across the skin in any direction to provide cellulite treatment.

In one embodiment, a valve assembly may be provided adjacent the first opening 36 of the housing 30 to permit the user to adjust the intensity of the suction delivered to the second opening 38. The valve assembly may include a c-ring valve located between the first opening 36 and the hose 18. In other embodiments, the valve assembly may include a ball valve, a slide valve, or the like.

With reference to FIG. 5, in another embodiment, a vibration motor 45 is provided within the housing 30 to subject the housing 30 to mechanical vibration for facilitating the delivery of massage treatment. The vibration motor 45 may be connected to an auxiliary power source 48.

With reference to FIGS. 4 and 5, in other embodiments, the present invention further includes a sensor 50 integrated into the housing 30 for monitoring movement of the housing across the skin. In the described embodiment, the sensor 50 is an optical sensor powered by the auxiliary power source 48 and mounted adjacent the bottom portion 34 of the housing and substantially between two roller balls 40. The sensor 50 is configured to detect movement of the housing 30 and to generate a corresponding output signal representative of a measure of movement of the housing 30. A programmable controller 52 receives the output signal from the sensor 50. When the output signal from the sensor 50 indicates a lack of or insufficient movement of the housing, the programmable controller 52 is configured to supply a reduction signal to the suction source 15 which causes the suction source 15 to substantially reduce or shut off suction. The reduction in suction serves as an indication to the user that the housing 30 should be kept in motion to prevent bruising or marking.

In other embodiments, the programmable controller 52 may be configured to activate an alarm when a lack of or insufficient movement of the housing is detected. Such an alarm may include activating an LED 53 located on the housing or, as shown in FIG. 1, on the portable container 20 to visibly prompt the user to resume movement of the housing. Other alarms may include activating an audio alarm or shutting off the vibration motor 45.

With reference to FIG. 5, in one embodiment a circuit board 60 may be provided within the portable container 20 for mounting the controller 52 and the auxiliary power source 48. The circuit board 60 may be mounted to the underside of the shelf 70 (FIG. 1). In certain embodiments, the hose 18 may be an electric hose and the vibration motor 45 and the sensor 50 may be connected to the circuit board 60 via the electric hose 18.

In accordance with the present invention, a portable system 10 is provided that includes a hand-held, easy to manipulate housing 30 that is suitable for an individual to use on his or her own body, and which may be moved across the skin in any direction for delivering massage treatment and suction to the skin for treating cellulite.

While this invention has been described with reference to preferred embodiments thereof, it is to be understood that variations and modifications can be affected within the spirit and scope of the invention as described herein and as described in the appended claims.

I claim:

1. An apparatus for treating cellulite to be used with a suction source, comprising:
a. a housing having a bottom portion;
b. a first opening on the housing for communication with the suction source;
c. a second opening on the housing in communication with the first opening, wherein the second opening is located adjacent the bottom portion for delivering suction from the suction source; and
d. a plurality of roller balls disposed around the second opening for delivering massage treatment.

2. The apparatus of claim 1 wherein the plurality of roller balls are mounted in cavities adjacent the bottom portion of the housing and wherein each of the plurality of roller balls is freely rotatable.

3. The apparatus of claim 1 further comprising a motor located within the housing for subjecting the housing to mechanical vibration.

4. The apparatus of claim 1 further comprising a sensor integrated into the housing for monitoring movement of the housing.

5. The apparatus of claim 4 wherein the sensor generates an output signal representative of a measure of movement of the housing, and further comprising a controller responsive to the output signal for indicating insufficient movement of the housing.

6. The apparatus of claim 5, wherein indicating insufficient movement of the housing includes substantially reducing or shutting off suction from the suction source.

7. The apparatus of claim 5, wherein indicating insufficient movement of the housing includes activating an alarm.

8. An cellulite treatment system, comprising:
a. a portable container;
b. a suction source located inside the portable container;
c. a housing sized to fit inside the portable container, wherein the housing has a bottom portion;
d. a first opening on the housing adapted to be removably affixed to the suction source;
e. a second opening on the housing in communication with the first opening, wherein the second opening is located adjacent the bottom portion for delivering suction from the suction source; and
f. a plurality of roller balls disposed around the second opening for delivering massage treatment.

9. The cellulite treatment system of claim 8 wherein the plurality of roller balls are mounted in cavities adjacent the bottom portion of the housing and wherein each of the plurality of roller balls is freely rotatable.

10. The cellulite treatment system of claim 8 further comprising a motor located within the housing for subjecting the housing to mechanical vibration.

11. The cellulite treatment system of claim 8 further comprising a sensor integrated into the housing for monitoring movement of the housing.

12. The cellulite treatment system of claim 11 wherein the sensor generates an output signal representative of a measure of movement of the housing, and further comprising a controller responsive to the output signal for indicating insufficient movement of the housing.

13. The cellulite treatment system of claim 12, wherein indicating insufficient movement of the housing includes substantially reducing or shutting off suction from the suction source.

14. The cellulite treatment system of claim 12, wherein indicating insufficient movement of the housing includes activating an alarm.
